(19) United States
(12) Patent Application Publication
(10) Pub. No.: US 2025/0121435 A1
(43) Pub. Date: Apr. 17, 2025

(54) ENERGY BEAM EXPOSURES IN POWDER BED FUSION

(71) Applicant: RENISHAW PLC, Wotton-under-Edge, Gloucestershire (GB)

(72) Inventors: Ravi Guttamindapalli ASWATHANARAYANASWAMY, Wotton-under-Edge (GB); Satyendra Singh KUTIYAL, Wotton-under-Edge (GB); Andrew FARNDELL, Wotton-under-Edge (GB); Nicholas Henry Hannaford JONES, Wotton-under-Edge (GB)

(73) Assignee: RENISHAW PLC, Wotton-under-Edge, Gloucestershire (GB)

(21) Appl. No.: 18/727,486

(22) PCT Filed: Jan. 6, 2023
(86) PCT No.: PCT/GB2023/050017

§ 371 Date: Jul. 9, 2024

(30) Foreign Application Priority Data
Jan. 10, 2022 (GB) 2200245.5
Jan. 10, 2022 (GB) 2200246.3
Jan. 10, 2022 (GB) 2200247.1

(51) Int. Cl. B22F 10/28; B22F 12/43; B33Y 10/00; B33Y 50/02

(52) U.S. Cl. CPC B22F 10/28; B22F 12/43; B33Y 10/00; B33Y 50/02

(57) ABSTRACT

A powder bed fusion additive manufacturing method including exposing layers of a powder bed to an energy beam to selectively melt areas of each layer, at least a proportion of the areas are melted using a pulsed exposure. The method may further include commanding an energy beam source to produce at least one pulse of the pulsed exposure having a pulse duration of less than 200 microseconds. The step of commanding may include specifying a plurality of raised power levels above a base power level for the powder waveform of the at least one pulse.

### FIELD OF INVENTION

This invention relates to energy beam exposures in powder bed fusion and in particular pulsed exposures.

### BACKGROUND

In powder bed fusion, a powder layer is deposited on a powder bed in a build chamber and an energy beam, such as a laser or electron beam, is scanned across portions of the powder layer that correspond to a cross-section (slice) of the workpiece being constructed. The energy beam melts the powder to form a solidified layer. After selective solidification of a layer, the powder bed is lowered by a thickness of the newly solidified layer and a further layer of powder is spread over the surface and solidified, as required. In a single build, more than one part can be built, the parts spaced apart in the powder bed. It is known to melt the powder layer simultaneously with more than one energy beam.

The energy beam is typically scanned along scan paths. The scanning of the energy beam along the scan path can be in continuous mode, in which the intensity of the energy beam is increased to an intensity level sufficient to melt the powder and the spot directed along the scan path with the intensity maintained at this level (referred to hereinafter as “continuous exposure”). In an alternative pulsed mode, the energy beam is emitted as a train of pulses, with each pulse directed to a different region along a scan path (referred to hereinafter as “pulsed exposure”). The pulses of the pulsed exposures may be synchronised with control of beam steering components that direct the energy beam to the powder bed with the aim of moving the beam steering components only when the energy beam is switched off such that the energy beam is stationary during an exposure. In reality, this is difficult to achieve for the scan speeds typically used in powder bed fusion due to the inertia of the beam steering components and some movement of the energy beam on the surface of the powder bed will occur during a pulse.

Renishaw's RenAM 500 Q machine enables scanning of the powder bed using a pulsed exposure with pulse durations of around 80 microseconds. The apparatus comprises four 500 W continuous wave (CW) lasers. The lasers are redPOWER PRISM module fibre lasers supplied by SPI. A controller of each CW laser comprises a Class A power amplifier for generating control signals to the pump diodes of the laser. A square-wave control signal modulates the output of the CW laser between on (a single raised power level) and off to generate the laser pulses as shown in FIG. 1. A maximum laser power for each laser pulse is pre-set, for example by a user. A rise time (from 10% to 90% of the maximum laser power) and fall time (from 90% to 10% of the maximum laser power) of the pulse is around 8 microseconds. A change in the maximum power of the laser pulses takes milliseconds, i.e. tens of pulses. An arrival time of the first pulse may vary by up to 7 microseconds, whereas an arrival time of later pulses is less variable. A lag time from the beginning of the control signal to arrival of the pulse is typically around 17 microseconds. It has been observed that the first laser pulse may exhibit a spike in power at the start of the laser pulse before plateauing at the maximum laser power pre-set for the laser pulse.

WO2018/029478 A1 discloses a pulse shape (waveform) of a laser pulse may include a plurality of sub shapes in which each one of the sub shapes can have different duration, energy, and ramp up or down. A waveform is illustrated having an intensity that increases slowly with three plateaus compared to a relative rapid decrease in the intensity. The total duration of the laser pulse can vary between 200 microseconds and 1000 microseconds.

“Selective Laser Melting of thin wall parts using pulse shaping”, K. A. Mumtaz, N. Hopkinson, investigates pulse shaping in selective laser melting. The system enabled the user to tailor the energy distribution to the nearest 0.5 ms within a single laser pulse. A variety of ramp up and ramp down pulse shapes were generated and used to process four layers of Inconel 625. The ramp up pulses varied from 1.7 ms to 10 ms. The ramp down pulses varied between 1 ms and 10 ms.

### SUMMARY OF INVENTION

According to a first aspect of the invention there is provided a powder bed fusion additive manufacturing method comprising exposing layers of a powder bed to an energy beam to selectively melt areas of each layer, wherein at least a proportion of the areas are melted using a pulsed exposure, the method further comprising commanding an energy beam source to produce at least one pulse, and preferably each of a plurality of pulses, of the pulsed exposure.

The step of commanding may comprise specifying a plurality of raised power levels above a base, such as zero, power level for the powder waveform of the at least one pulse. In the invention the step of commanding comprises specifying each of the plurality of raised power levels, for example in a control signal sent to or that drives the energy beam source. In this way, an intended pulse shape can be achieved that is different to pulses generated by simple on/off commands, i.e. commands that only specify one (“on”) raised power level during a pulse.

The step of commanding may comprise specifying a pulse shape, pulse profile and/or pulse form for the power waveform. The power waveform may be a non-rectangular pulse shape/profile/form. It has been found that a non-rectangular pulse shape/profile/form may result in changes in how material is consolidated that can improve parts compared to those produced using rectangular pulses. The pulse shape/profile/form may be triangular. The pulse shape/profile/form may comprise a plurality of power plateaus at the specified raised power levels.

A pulse duration (a time between the laser power of the pulse rising above and then returning back to below 10% of a maximum specified raised power level) of the at least one, a preferably each of a plurality, of the pulses of the pulsed exposure may be less than 200 microseconds, and optionally less than 150 microseconds. It has been found that longer pulse durations result in vaporisation of material at the energy beam powers required to melt powder, in particular metal powder. Reducing the power of the energy beam below this threshold will result in the powder not being melted even if exposed to the energy beam for longer as the heat dissipates too quickly for the temperature of the powder to rise above the melting temperature for such low energy beam powers. Accordingly, a pulsed exposure comprising pulse durations longer than 200 microseconds is undesirable.

The pulse duration may be greater than 1 microsecond, preferably greater than 5 microseconds and optionally greater than 10 microseconds.

The energy beam source for generating the energy beam may have a response time (a time between a change in a control signal and a corresponding change in the output energy beam to a demanded power) of 10 microseconds or less and preferably 5 microseconds or less. Controlling the shape of the power waveform may comprise specifying one or more raised power levels between 10% and 90% of a maximum raised power level. The method may comprise specifying one or more raised power levels as having a duration of less than 15 microseconds, optionally less than 10 microseconds, and further optionally, less than 5 microseconds. The method may comprise controlling the shape of the power waveform to increase or decrease in a plurality of steps. At least one of the steps may have a duration of less than 15 microseconds, optionally less than 10 microseconds, and further optionally less than 5 microseconds. The at least one of the steps may have a duration of greater than 1 microsecond, and further optionally greater than 2 microseconds.

The method may comprise specifying a pulse shape to control a cooling rate of melt and/or resolidified material. In powder bed fusion, metal material typically solidifies within tens of microseconds and thus, melted material rapidly resolidifies after an intensity of the energy beam falls below that sufficient to maintain the temperature of the material above a melting point. It has been found that lengthening a fall time of an energy beam pulse to be greater than the 8 microseconds uncontrolled fall time achieved in Renishaw's RenAM 500 Q machine can result in improved material properties for the solidified material. (The fall time in Renishaw's RenAM 500 Q machine is uncontrolled/unspecified in so far that the fall time is not defined by the control signals, which are square pulses with vertical rise and fall times, but results from the non-idealistic response of the laser to such control signals). The method comprises controlling the shape of the power waveform of pulses of the pulsed exposure such that the fall time is longer than the rise time. The method comprises controlling the shape of the power waveform of pulses of the pulsed exposure such that a fall time of the at least one pulse is greater then 10 microseconds, preferably greater than 20 microseconds and most preferably around 30 microseconds. The fall time may be less than 100 microseconds, preferably less than 50 microseconds and most preferably less than 40 microseconds. The fall time of the at least one pulse may be between 10 and 100 microseconds, between 10 and 50 microseconds, between 10 and 40 microseconds, between 20 and 100 microseconds, between 20 and 50 microseconds, or between 20 and 40 microseconds. The maximum raised power may be between 200 W and 1000 W. An average gradient of the fall time may be between 2 and 20 MW/s, preferably between 4 and 20 MW/s and more preferably between 6 and 20 MW/s. Extending the fall time of the pulse may affect the cooling rate during solidification of the melted material, in turn altering the resultant microstructure. The fall time should be of the order of the time it takes for the melted material to solidify, e.g. tens of microseconds, in order that the cooling rate is altered by the extended fall time but unnecessary holding of the material at an elevated temperature is avoided. The lower cooling rate may reduce solidification cracking in certain materials, such as steels, for example tool steels like H13 tool steel, W360 or Nickel-base superalloys.

The method may comprise controlling the shape of the waveform such that a rise time of the at least one pulse is greater than 10 microseconds, preferably greater than 20 microseconds and most preferably around 30 microseconds. The rise time may be less than 100 microseconds, preferably less than 50 microseconds and most preferably less than 40 microseconds. The rise time of the at least one pulse may be between 10 and 100 microseconds, between 10 and 50 microseconds, between 10 and 40 microseconds, between 20 and 100 microseconds, between 20 and 50 microseconds, or between 20 and 40 microseconds. The set maximum power may be between 200 W and 1000 W. An average gradient of the rise time may be between 2 and 20 MW/s, preferably between 4 and 20 MW/s and more preferably between 6 and 20 MW/s. A slower rise time than the uncontrolled rise time of the RenAM 500Q machine may result in a wider melt pool and/or a melt pool with a lower ratio of depth to width. It is desirable to form wide shallow melt pools for fast cooling rates and directional grain formation. Further details of such methods of directional grain formation are disclosed in WO2020/249932 A1 and PCT/GB2021/051193, the disclosure of which is incorporated herein in its entirety by reference.

The method may comprise controlling the shape of the power waveform to combine the rise time and the fall time of the at least one pulse as defined above.

The method may comprise controlling the shape of the power waveform such that at least one of the pulses comprises a plurality of maxima. Ones of the maxima may be above 90% of a set maximum raised power level for the pulse. Ones of the maxima may have a power above that required to melt the powder. Between each pair of maxima is an intermediate local minimum of the pulse. At least one of the intermediate local minima may be above 10%, and preferably above 90%, of a set maximum raised power level for the pulse. At least one of the intermediate local minima may have a power above that required to melt the powder. A time between the intermediate local minimum and an adjacent maximum may be between 1 and 50 microseconds, between 5 and 50 microseconds, between 10 and 50 microseconds, between 1 and 40 microseconds, between 5 and 40 microseconds, between 10 and 40 microseconds, between 1 and 30 microseconds, between 5 and 30 microseconds, between 10 and 30 microseconds, between 1 and 20 microseconds, between 5 and 20 microseconds, between 10 and 20 microseconds, between 1 and 17 microseconds, between 5 and 17 microseconds or between 10 and 17 microseconds. The oscillation of the power of the pulse during the exposure may agitate the melt pool to improve grain size homogeneity and/or improve penetration depth of the pulse.

According to a second aspect of the invention there is provided a powder bed fusion additive manufacturing method comprising exposing layers of a powder bed to an energy beam to selectively melt areas of each layer, wherein at least a proportion of the areas are melted using a pulsed exposure, at least one pulse, and preferably each of a plurality of pulses, of the pulsed exposure has a pulse duration of less than 20 microseconds.

Shorter pulse durations than the 80 microsecond pulses used in the RenAM 500 Q machine may result in finer microstructure and/or higher build rates.

The second aspect of the invention may be used in conjunction with the pulse shaping of the first aspect of the invention.

According to a third aspect of the invention there is provided a powder bed fusion additive manufacturing method comprising exposing layers of a powder bed to an energy beam to selectively melt at least one area of each layer, wherein the energy beam is progressed along a scan path to melt material of the at least one area using a pulsed exposure, initial and/or end pulses of the pulsed exposure have a shorter pulse duration than a pulse duration of a mid-pulse between the initial and end pulses.

The use of pulses at the start and/or end of a scan path may improve penetration of the material in these regions compared to initiating or ending a continuous exposure in these regions of a scan path.

The pulse duration of the mid-pulse may be of such a length that it is similar to scanning in continuous mode. The pulse duration of the mid-pulse may be greater than 80 microseconds, more preferably greater than 100 microseconds, even more preferably greater than 150 microseconds and yet more preferably greater than 200 microseconds.

The shorter pulse duration may be less than 200 microseconds, less than 100 microseconds, less than 80 microseconds, less than 50 microseconds, less than 30 microseconds or less than 20 microseconds.

The shorter pulse duration may be constant for all initial pulses and/or end pulses. Alternatively, the shorter pulse duration may vary for different ones of the initial pulses and/or end pulses. The shorter pulse duration for a first pulse and/or for a last pulse may be shorter than for other initial pulses or end pulses, respectively. The shorter pulse duration may progressively increase for the initial pulses from a first initial pulse to the mid-pulse. The shorter pulse duration may progressively decrease for the end pulses from the mid-pulse to the last end pulse.

A time between the pulses may be constant. Alternatively, a time between the pulses may vary. The time between a first pulse and second pulse or between a penultimate pulse and the last pulse may be longer than between other pairs of pulses of the pulsed exposure. The time between pulses may progressively decrease from a first initial pulse to the mid-pulse. The time between pulses may progressively increase from the mid-pulse to a last end pulse.

A point distance between the pulses may be constant. Alternatively, the point distance between the pulses may vary. The point distance between a first pulse and second pulse or between a penultimate pulse and the last pulse may be shorter than between other pairs of pulses of the pulsed exposure. The point distance between pulses may progressively increase from a first initial pulse to the mid-pulse. The point distance between pulses may progressively decrease from the mid-pulse to a last end pulse.

The methods may comprise synchronising the pulses with control of at least one beam steering component that directs the energy beam to the powder bed. Synchronising the pulses with control of the at least one beam steering component may comprise moving the at least one beam steering component, such as a mirror, relatively rapidly between pulses compared to a speed of movement of the at least one beam steering component during a pulse. Synchronising the pulses with control of the at least one beam steering component may comprise moving a target on the powder bed of the beam steering component, such as a mirror, relatively rapidly between pulses compared to a speed of movement of the target during a pulse. The term “target on the powder bed of the beam steering component” as used herein means a location on the powder bed that the energy beam is or would be directed if the energy beam is generated.

According to a fourth aspect of the invention there is provided a laser comprising a gain medium, a pump for pumping the gain medium and a controller for controlling the pump.

The controller may be arranged to control the pump such that a response time of the laser is less than 17 microseconds. The response time may be less than 10 microseconds and preferably less than 5 microseconds. The response time may be around 3 microseconds. The response time is a time between a control signal demanding a change in power and a change in power of the laser beam output from the laser. The term control signal as used herein means the signal received by the power amplifier of the laser.

Such response times are required for applications, such as powder bed fusion, wherein pulsed exposures have durations in the tens of microseconds.

The controller may be arranged to control the pump such that a plurality of steady non-zero laser beam powers can be output within a millisecond, preferably within 500 microseconds and more preferably within 200 microseconds, in response to a corresponding control signal. The term “steady” laser beam power means that the laser plateaus at that power for a period of time rather than a power through which the laser beam momentarily transitions when rising or falling between a zero and non-zero power. The plurality of steady non-zero laser beam powers may occur within a single pulse or across multiple pulses. The period of time of the steady non-zero laser beam power may be at least 1 microsecond and optionally at least 3 microseconds.

The controller may comprise a power circuit arranged to generate a pulse-width modulated signal to an inertial load located between the power circuit and the pump. The pulse-width modulated signal is generated by the power circuit in response to a control signal. The inertial load converts the digital pulse-width modulated signal to a smoother waveform (drive signal) for driving the pump, such as one or more laser diodes. Without the inertial load, the laser diodes would pulse with the pulse-width modulated signal. The inertial load may comprise an inductor. The inertial load may comprise a capacitor. The inertial load may comprise an inductor and a capacitor. The inductor and capacitor may be provided in series. The inertial load may be an electronic filter, such as a second order filter. The inductor acts to smooth the current and the addition of the capacitor forms the electronic filter.

The power circuit may comprise a switching power amplifier (Class D amplifier) for generating the pulse-width modulated signal. Class D power amplifiers are more efficient than Class A power amplifiers, which can result in significant advantages when a high electric power is to be applied to the pump as is the case in high power lasers (200 W or above). The laser may be capable of generating a laser beam with a power above 200 W, preferably above 300 W and more preferably above 400 W.

The switching power amplifier may comprise two switching transistors. Each switching transistor may be a GaN transistor. Each switching transistor may be a high-electron-mobility transistor. Conventional MOSFET transistors have a switching frequency of around 100 KHz (switching every 10 microseconds), too slow to achieve the response time required for the laser of the invention. GaN transistors/high-electron-mobility transistors can achieve much higher switching frequencies. For example, GaN transistors may be driven at 2.5 MHz (switching every 400 nanoseconds). Accordingly, the use of GaN transistors/high-electron-mobility transistors enables use of a switching power amplifier whilst still achieving the required response time for the laser. GaN transistors/high-electron-mobility transistors are also suitable for high voltage, high temperature and high efficiency applications.

The laser may comprise a plurality of controllers, each controller arranged to generate a drive signal to at least one laser diode to cause the at least one laser diode to pump the gain medium. Each controller may be arranged to generate drive signals to two or more laser diodes. In this way, a power achieved by the laser can be altered through changing the pulse width modulation of each controller and/or by activating/deactivating some or all of the controllers.

The gain medium may be a doped optical fibre. The optical fibre may be doped with neodymium. The laser may be a NG:YAG fibre laser. The laser may be a continuous wave laser.

According to a fifth aspect of the invention there is provided a powder bed fusion apparatus comprising an energy beam irradiation device for generating and directing an energy beam to a powder bed, the energy beam irradiation device comprising an energy beam source, and a controller arranged to control the energy beam source to carry out the method according to any one of the first, second and third aspects of the invention.

The energy beam irradiation device may comprise an energy beam source, such as a laser, and at least one beam steering component for directing the energy beam to selected locations on the powder bed. The energy beam source may be a laser according to the fourth aspect of the invention.

According to a sixth aspect of the invention there is provided a data carrier comprising instructions stored thereon, which, when executed by a controller of a powder bed fusion apparatus comprising an energy beam irradiation device for generating and directing an energy beam to a powder bed, the energy beam irradiation device comprising an energy beam source, the controller arranged to control the energy beam source to carry out the method according to any one of the first, second and third aspects of the invention.

The data carrier may be a suitable medium for providing a machine with instructions such as non-transient data carrier, for example a floppy disk, a CD ROM, a DVD ROM/RAM (including −R/−RW and +R/+RW), an HD DVD, a Blu Ray™ disc, a memory (such as a Memory Stick™, an SD card, a compact flash card, or the like), a disc drive (such as a hard disc drive), a tape, any magneto/optical storage, or a transient data carrier, such as a signal on a wire or fibre optic or a wireless signal, for example signals sent over a wired or wireless network (such as an Internet download, an FTP transfer, or the like).

### DESCRIPTION OF THE DRAWINGS

FIG. 1 shows the control signals and consequential laser pulses generated by a laser used in Renishaw's RenAM 500 Q powder bed fusion apparatus;

FIG. 2 is a schematic of a powder bed fusion apparatus according to an embodiment of the invention;

FIG. 3 is a perspective view of galvanometer system of an optical scanner of the powder bed fusion apparatus shown in FIG. 1;

FIG. 4 is a schematic of scanning parameters according to an embodiment of the invention;

FIG. 5 is a schematic of a laser according to an embodiment of the invention for use in the powder bed fusion apparatus;

FIG. 6 is a circuit diagram of a power circuit and pump diodes of the laser;

FIGS. 7a to 7h show power waveforms for pulses of a pulsed exposure according to embodiments of the invention;

FIG. 8a shows microscope images of regions of a sample built using initial blast pulses; FIG. 8b shows microscope images of regions of a sample built using rectangular pulses; and FIG. 8c shows microscope images of regions of a sample built using gradual cooling pulses;

FIGS. 9a to 9d are scanning electron microscope (SEM) of the samples formed using gradual cooling pulses;

FIG. 10a is an image of a surface of a cube built using the rectangular pulses and FIG. 10b a corresponding image of a surface of a cube built using gradual cooling pulses.

FIG. 11a shows cross-sectional images of cubes built in H13 tool steel using different gradual cooling pulses with (1) 5 μs steps, (2) 10 μs steps, (3) 15 μs steps, (4) 10 μs steps with revised power, and (5) 15 μs steps with revised power; and FIG. 11b is a table of the resultant density measurements;

FIGS. 12a to 12d are images of the exposure of a bare substrate to a rectangular pulse (FIG. 12a), to a triangular pulse (FIG. 12b), to an initial blast pulse (FIG. 12c), and to a gradual cooling pulse with 5 μs steps (FIG. 12d).

FIGS. 13a to 13d are images of the exposure of a bare substrate to a pulsed exposure comprising a plurality of: (i) rectangular pulses (FIG. 13a), (ii) gradual cooling pulses with 5 μs steps (FIG. 13b); (iii) initial blast pulses (FIG. 13c), and (iv) triangular pulses (FIG. 13d);

FIG. 14 is a graph of hardness measurements made on samples formed using rectangular pulses and gradual cooling pulses;

FIG. 15 is a table showing parameters used to build a number of samples using short rectangular pulses and density measurements of those samples;

FIGS. 16a to 16d show power waveforms for blended pulsed exposures according to embodiments of the invention;

FIG. 17 is a table showing the powers used for different gradual cooling pulses used in Example 3; and

FIGS. 18a and 18b show cross-sectional images of cubes built in IN718 using rectangular pulses (FIG. 18a) and initial blast pulses (FIG. 18b).

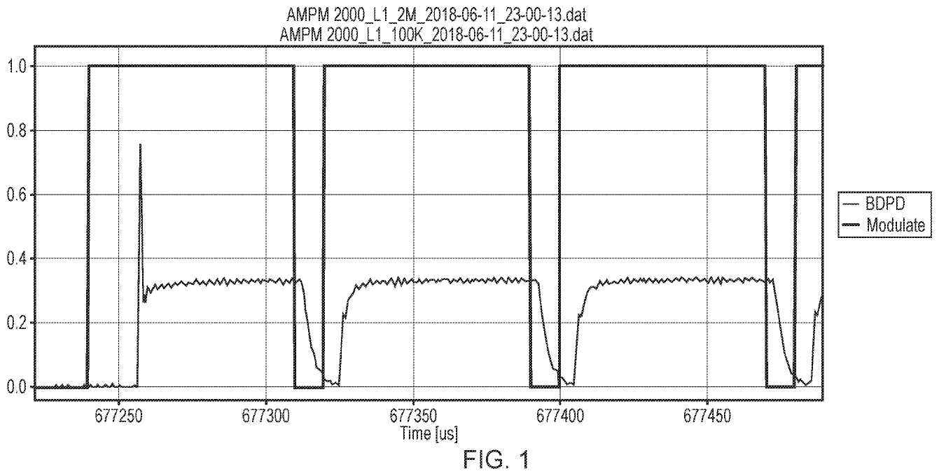

### DESCRIPTION OF EMBODIMENTS

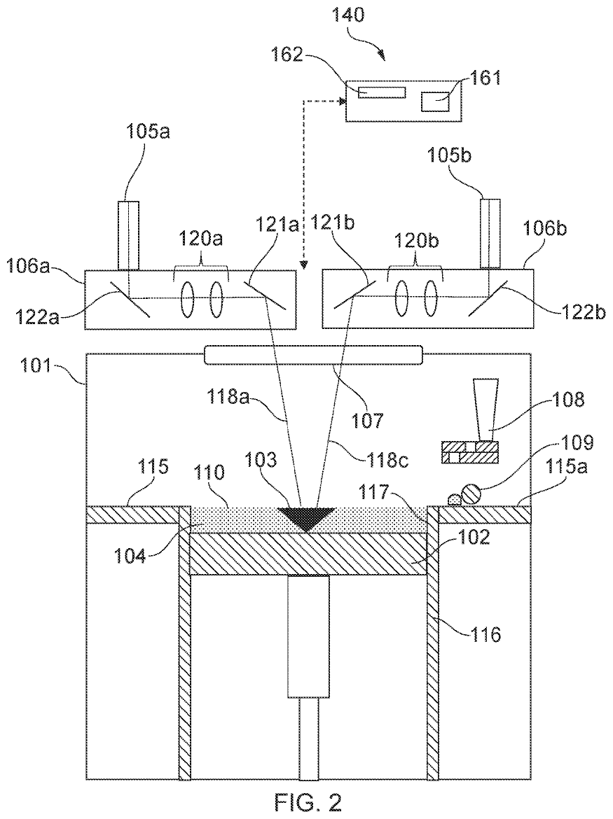

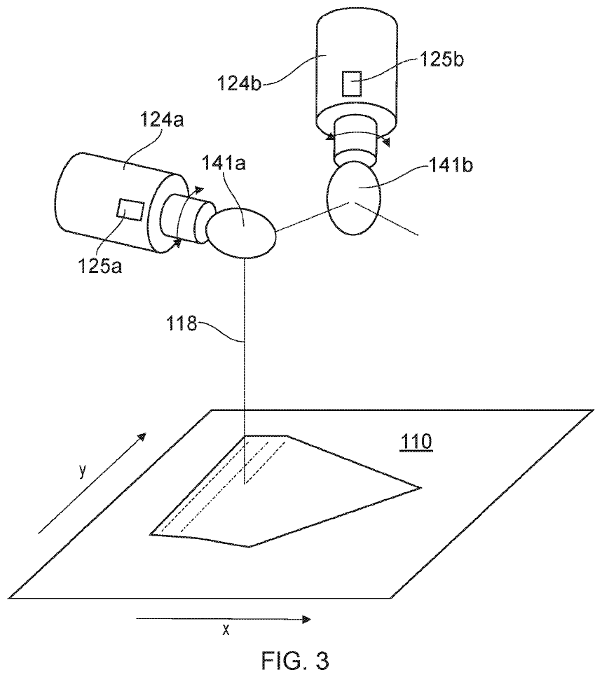

Referring to FIGS. 2 and 3, a powder bed fusion apparatus according to an embodiment of the invention comprises a build chamber 101 having therein a processing plate 115 having an aperture therein and a build sleeve 116 extending down from the aperture. A build platform 102 is lowerable in the build sleeve 116 such that build sleeve 116 and build platform 102 together define a build volume 117. The build platform 102 supports a build substrate plate 102a, a powder bed 104 and workpiece (object) 103 as the workpiece is built by selective laser melting of the powder. The platform 102 is lowered within the build volume 117 under the control of a drive mechanism (not shown) as successive layers of the workpiece 103 are formed.

Layers of powder 104 are formed as the workpiece 103 is built by dispensing apparatus 108 and a recoater 109. For example, the dispensing apparatus 108 may be apparatus as described in WO2010/007396. The dispensing apparatus 108 dispenses powder onto an upper surface 115a defined by processing plate 115 and is spread across the powder bed by the recoater 109. A position of a lower edge of the recoater 109 defines a working plane 110 at which powder is consolidated.

A plurality of laser modules 105a, 105b generate laser beams 118a, 118b for melting the powder 104 and each module 105a, 105b is arranged to deliver the laser beam to a corresponding optical scanner 106a, 106b. The optical scanner 106a, 106b steers the laser beams 118a, 118b on to selected areas of the powder bed 104 in order to build the object. The laser beams 118a, 118b enter through a common laser window 107.

Each optical scanner 106a, 106b comprises steering components in the form of movable steering optics 121, such a two mirrors 141a, 141b mounted on galvanometers 124a, 124b (see FIG. 3), for steering the laser beam 118 in perpendicular directions, X and Y, across working plane 110 and focusing optics 120, such as two movable lenses for changing the focus of the laser beam 118. The optical scanner is controlled such that the focal position of the laser beam 118 remains in the same plane 110 as the laser beam 118 is moved across the working plane 110. Angular position sensors 125a, 125b are integrated into each galvanometer 124a, 124b for measuring an angular position of the corresponding mirror 121a, 121b.

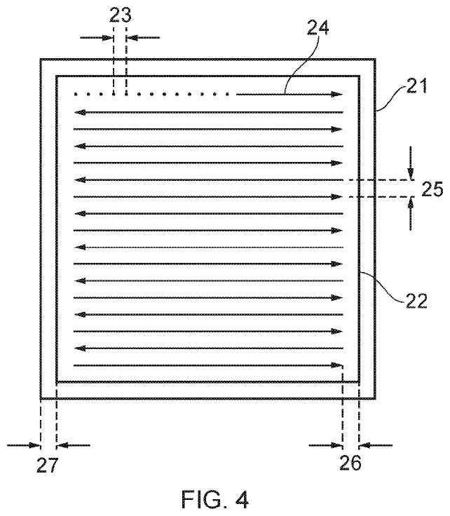

In one scanning regime, the movement of the mirrors 141a, 141b is synchronised with laser beam pulses generated by the laser 105 to exposure the powder bed 104 using a pulsed exposure. The angular position sensors 125a, 125b may be used for providing feedback to the laser 105 to ensure appropriate synchronisation between movement of the mirrors 141a and 141b and firing of the laser 105. FIG. 4 shows scanning parameters used to define the pulsed exposure. FIG. 4 illustrates scan paths comprising raster scans 24 for forming a core of a consolidated layer surrounded by border scans 21 and 22 for forming edges of the consolidated layer. A distance between scan paths of the raster scan is defined by a hatch distance 25 and a distance between the scan paths of the border and raster scans by border offsets 26 and 27. One or more or all of the scan paths may be formed using pulsed exposures. The pulsed exposure is defined by a point distance 23 and exposure time (pulse duration) for each exposure. The system may also implement a jump delay which defines a time the mirrors are allowed to settle after moving between point before the laser is fired. The jump delay may be varied depending upon point distance. It may be possible to eliminate the use of jump delays if mirror movement during an exposure is deemed acceptable or a scanning system is used that compensates for such mirror movement, for example as disclosed in WO2016/156824, which is incorporated herein in its entirety.

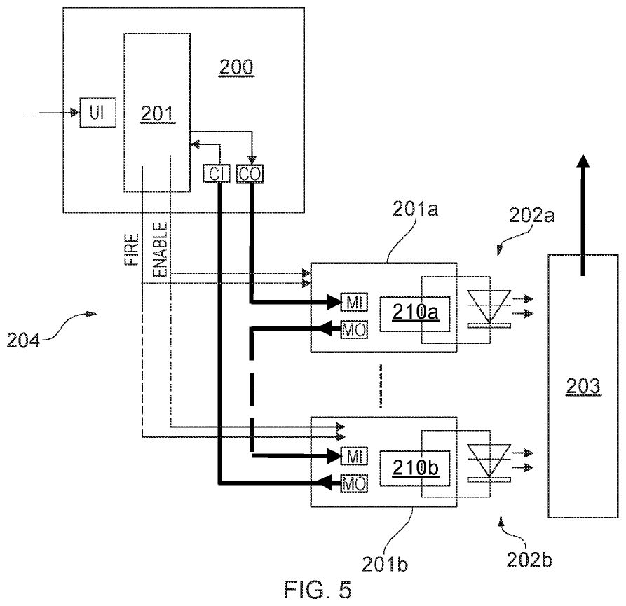

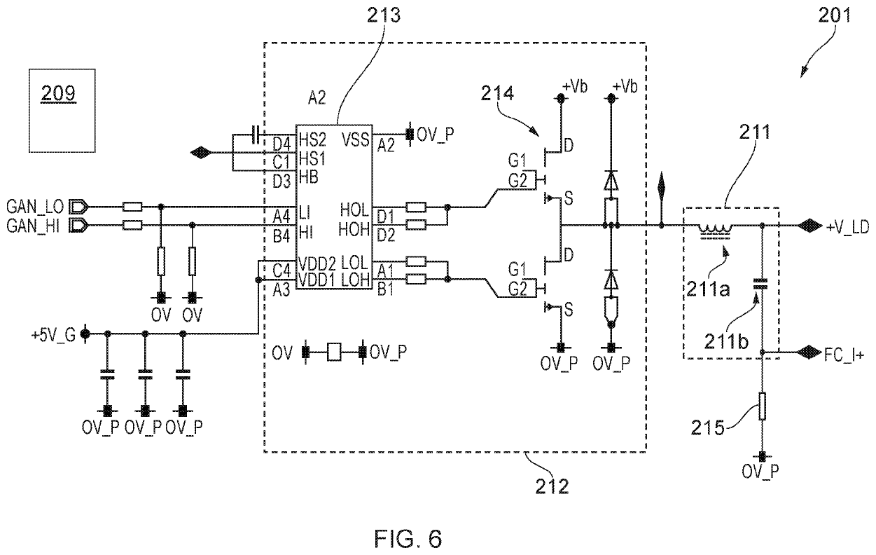

Referring to FIGS. 5 and 6, the laser 105 comprises a master laser controller 200, such as a programmable integrated circuit, programmed with firmware 201, and a plurality of laser diode controllers 201a, 201b, each for controlling a different set 202a, 202b of laser diodes to pump a gain medium 203, such as a neodymium doped optical fibre. In this embodiment, each set of laser diodes 202a, 202b consists of two laser diodes. Only two laser diode controllers 201a, 201b are shown for simplicity but typically more than two laser diode controllers 201a, 201b are provided. In this embodiment, six laser diode controllers 201a, 201b are provided. Accordingly, in total twelve laser diodes can be used to pump the doped optical fibre 203.

The master controller 200 communicates with the laser diode controllers 201a, 201b via a communication interface 204. In this embodiment, the communication interface 204 is a serial peripheral interface (SPI) synchronous bus. Instructions in the form of control signals (data packets) sent by the master laser controller 200 may be addressed to an individual laser diode controller 201a, 201b or broadcast to all of the laser diode controllers 201a, 201b. Accordingly, the laser diode controllers 201a, 201b can be controlled individually or as a group by the master controller 200. The instructions sent to each laser diode controller 201a, 201b define a demanded output of the set 202a, 202b of laser diodes controlled by that laser diode controller 201a, 201b. Each laser diode controller 201a, 201b is also connected to the master controller 200 by FIRE and ENABLE communication lines. A user interacts with the master controller via the user interface UI to set controls and read status.

Each laser diode controller 201a, 201b comprises a power circuit 210a, 210b, which generates a pulse-width modulated signal to an inertial load 211. In this embodiment, the inertial load comprises an inductor 211a and at least one capacitor 211b connected in series to form a second-order filter. The inertial load 211 converts the digital pulse-width modulated signal to a smoother (or “average”) waveform (drive signal)+V_LD for driving the laser diodes.

The power circuit 210a, 210b comprises a programmable device, in this embodiment a field programmable gate array 209, and a switching amplifier 212.

The programmable device 209 processes control signals (instructions) received from the master controller 200 and generates low voltage and low current output signals corresponding to the desired switching state of the GaN transistors (described below).

The switching amplifier 212 includes a half H-bridge 214 connected across a high voltage power supply. The half H-bridge 214 comprises two GaN transistors. The switching amplifier 212 further comprises a GaN driver 213 connected to gates of GaN transistors of the half H-bridge 214. The GaN driver 213 receives the output signals from the programmable device 209 and converts these output signals into corresponding higher voltage and higher current switching signals suitable for driving the GaN transistors of the half H-bridge 214.

The programmable device 209 controls switching of the transistors to generate a pulse-width modulated signal such that an output from the set 202 of laser diodes corresponds to a demanded output as encoded in the received control signals, as described in more detail below. A drive current delivered to the laser diodes is monitored across resistor 215.

When the ENABLE parameter is set and the ENABLE signal is high, the laser diode controller 201a, 201b is enabled to drive a current into the laser diodes. The amount of current will depend upon the state of the FIRE signal and the values of the GAN-LO and GAN-HI parameters. When FIRE is low, the current demand is set by the GAN-LO parameter. When FIRE is high, the current demand is set by the GAN-HI parameter.

The master controller 200 drives the FIRE signal and sets the GAN-HI and GAN-LO parameters of the laser diode controllers 201a, 201b as required to command the power circuit 210a, 210b to generate drive signals in accordance with a required pulse shape. The master controller 200 can be pre-programmed with a library of pulse sequences and/or pulse shapes such that the user/powder bed fusion apparatus can select a pulse sequence and/or a pulse shape from the library, as required. However, in addition or alternatively, the master controller 200 may be programmed to generate pulse sequences and/or pulse shapes based on aspects of a pulse sequence(s) and/or a pulse shape(s) encoded in received commands. In this way, the laser may be controlled to generate pulse sequences and/or pulse shapes beyond those contained in the library.

A response time (a time between a change in the control signal and a corresponding change in the output laser beam to a demanded power) of the laser is typically 5 microseconds or less.

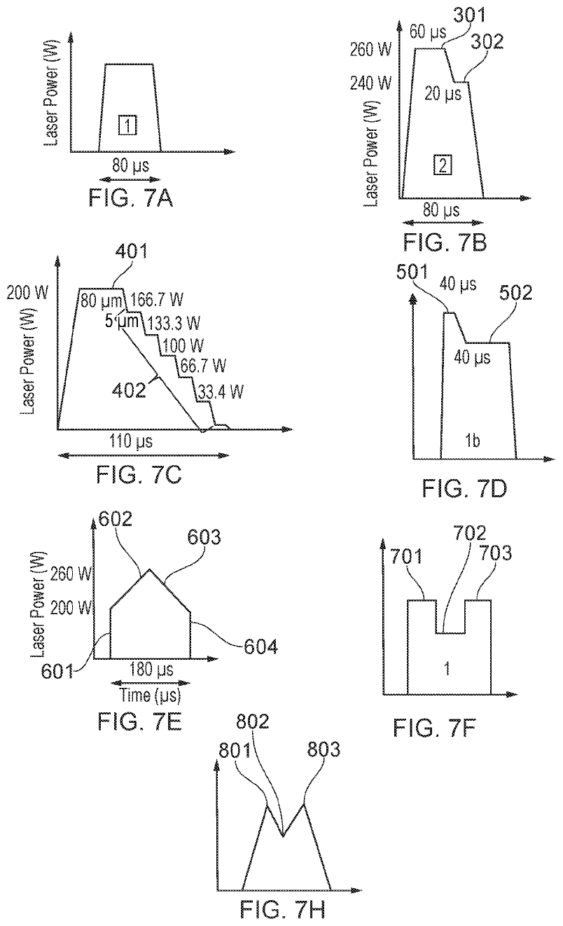

FIGS. 7a to 7e illustrate pulse shapes achievable with the laser.

In FIG. 7a, the pulse shape is a substantially rectangular pulse that rises to a maximum power of the pulse, is held at the maximum power for a set duration, typically longer than 5 microseconds, and then falls to a minimum base power within 5 microseconds. With a laser according to the invention, the rise and fall of the power can be achieved within 5 microseconds of the control signal for such a pulse being generated. When using such a pulse for a pulsed exposure in powder bed fusion, any delay between firing of the laser and a laser beam being generated can be reduced compared to prior art systems, allowing closer and/or improved synchronisation of the laser with the scanner as less leeway has to be provided for variability in the firing time of the laser.

In another embodiment, a pulse shape with a stepped decrease in a raised power level is provided. The pulse comprises an initial rise to a first, preferably higher, raised power. The rise time to the first raised power may be in less than 15 microseconds, preferably less than 10 microseconds and more preferably less than 5 microseconds. The first raised power is maintained as a plateau in the power for a first time period that is 5 microseconds or more, before reducing to one or more second raised powers less than the first raised power, the power plateauing at the or each second raised power. The or each second raised power may be maintained as a plateau in the power for a (second) time period that is 5 microseconds or more. The fall time between the first and the or a one of the second raised powers and between pairs of second raised powers may be in less than 15 microseconds, preferably less than 10 microseconds and more preferably in less than 5 microseconds. Finally, the laser pulse returns to a base power (a power that is below 10% of the first raised power or zero power).

FIG. 7b shows an example a pulse shape with a stepped decrease in power having a having a first raised power plateau 301 and a single second raised power plateau 302 (an initial blast pulse). In FIG. 7b, the first raised power plateau 301 has a longer duration than the second raised power plateau 302, although it would be understood that the duration of the first and second raised power plateaus 301, 302 could be the same or the second raised power plateau 302 could be longer the first raised power plateau 301. In this embodiment, the first raised power plateau 301 is for 60 microseconds at 280 W and the single second raised power plateau 302 is for 20 microseconds at 240 W. The power of both the first and second raised power plateaus 301, 302 would be sufficient to melt powder for the laser spot size, in this embodiment a 1/e² spot size of 60 to 80 micrometres.

FIG. 7c is a further example a pulse shape with a stepped decrease in power having a first raised power plateau 401 and a plurality of second raised power plateaus 402 at ever decreasing power (gradual cooling pulse). In FIG. 7c, the first raised power plateau 401 has a longer duration than the second raised power plateaus 402, although it would be understood that the duration of the first and second raised power plateaus 401, 402 could be the same or at least one of the second raised power plateaus 402 could be longer than the first raised power plateau 401. In this embodiment, the first raised power plateau 401 is for 80 microseconds at 200 W and each second raised power plateaus 402 is for 5 microseconds at a power reduced by approximately the same amount for each step, in this example by 33.3/33.4 W. However, it will be understood that other sized steps in power could be used and other durations for the second plateaus 402. Furthermore, all of the second plateaus 402 do not have to have the same duration. This example differs from that of FIG. 7b in that at least some, if not all, of the second plateaus 402 provide insufficient fluence at the powder bed to melt the powder for the laser spot size, in this embodiment 1/e² spot size of 60 to 120 micrometres at the plane of the powder bed.

FIG. 7d is a further example a pulse shape with a stepped decrease in power similar to that shown in FIG. 7b but with the first plateau 501 and the second plateau 502 having the same duration, in this embodiment 40 microseconds.

In another embodiment shown in FIG. 7e, a pulse shape comprises at least a portion having a triangular shape (triangular pulse). In this embodiment, the pulse comprises a first rising portion 601 that rises, for example in less than 5 microseconds, from a base power to a first raised power, in this example 200 W, a second rising portion 602 in which the power rises relatively gradually compared to the first rising portion to a second, peak raised power, in this example 280 W, a first falling portion 603 in which the power decreases to a third raised power, in this example the same as the first raised power, and a second falling portion 604 in which the power decreases relatively rapidly, such as in less than 5 microseconds, compared to the first falling portion to a base level. The first and second raised powers may provide a fluence at the powder bed for the given laser spot size that is sufficient to melt the powder. In this embodiment, the laser beam has 1/e² spot size of 60 to 120 micrometres at the plane of the powder bed.

Referring to FIGS. 7f and 7h, in another embodiment, a pulse shape configured to agitate the melt pool is provided (agitating pulse). In such an embodiment, the pulse shape comprises a plurality of peaks (maxima) that oscillate between powers that provide a fluence at the powder bed sufficient to the melt the powder. The pulse can be viewed as a rectangular or triangular pulse (having a pulse duration of between 20 and 200 microseconds, and more preferably between 20 and 100 microseconds and typically around 80 microseconds) having a (superposed) pulse wave with shorter duration of pulses superposed thereon. In this embodiment, the power initially rises 701, 801 to a first raised power. The power may then be held at the first raised power (plateau in FIG. 7f) before being reduced to a second raised power 702 or the power may be immediately reduced to the second raised power 802 (FIG. 7h). The power may then be held at the second raised power (plateau 702 in FIG. 7f) before being increased to a third raised power 703 or the power may be immediately increased to the third raised power 803 (FIG. 7h). The third power 703, 803 may be the same or different from the first raised power 701, 801. In the examples shown in FIG. 7f, the power is held at the third raised power (plateau 706) before being reduced to the base/zero power. In FIG. 7h, the power is immediately reduced to the base/zero power. Accordingly, FIG. 7f illustrates a castellation pulse shape comprising a rectangular superposed pulse wave oscillating between the first and second raised powers. FIG. 7h illustrates a pulse shape comprising a triangular superposed pulse wave oscillating between the first and second raised powers. It will be understood that other shaped superposed pulse waves could be used such as sawtooth or sinusoidal pulse waves oscillating between the first and second raised powers. Furthermore, the initial rise to the first raised power and the fall to the base/zero power (for any of the different shaped pulse waves) may be gradual (possibly in steps), such as over a period longer than 5 microseconds, (as shown in FIG. 7h) or rapid, such as over a period less than 5 microseconds (as shown in FIG. 7f). It will be understood that the superposed pulse wave of the pulse may comprise more than two peaks.

### Example 1

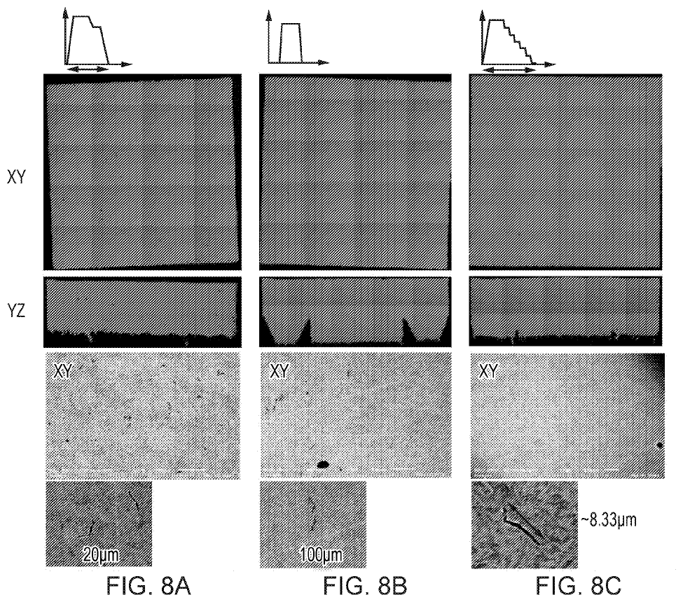

10 mm×10 mm×11.75 mm cubes were built in H13 tool steel in a RenAM 500E powder bed fusion machine modified to replace the PRISM laser with a laser according to the invention. Different pulsed exposures were used to form the cubes, the pulsed exposures comprising (i) initial blast pulses (FIG. 7b), (ii) rectangular pulses (FIG. 7a) and (iii) gradual cooling pulses (FIG. 7c). The build parameters were: laser spot size 80 μm, point distance 65 μm, hatch distance 80 μm, and a layer thickness of 40 μm. FIGS. 8a, 8b and 8c show cross-sections of the cubes under different magnifications. FIG. 8a shows images for the initial blast pulses, FIG. 8b shows corresponding images for the rectangular pulses and FIG. 8c shows corresponding images for the gradual cooling pulses.

The initial blast samples and rectangular samples resulted in a higher number of cracks compared to the samples formed using gradual cooling pulses. Furthermore, as can be seen from the images, the gradual cooling pulses resulted in smaller cracks than the rectangular pulses and initial blast pulses. Most of these smaller cracks had a smooth surface, implying that these cracks did not result from solidification cracking.

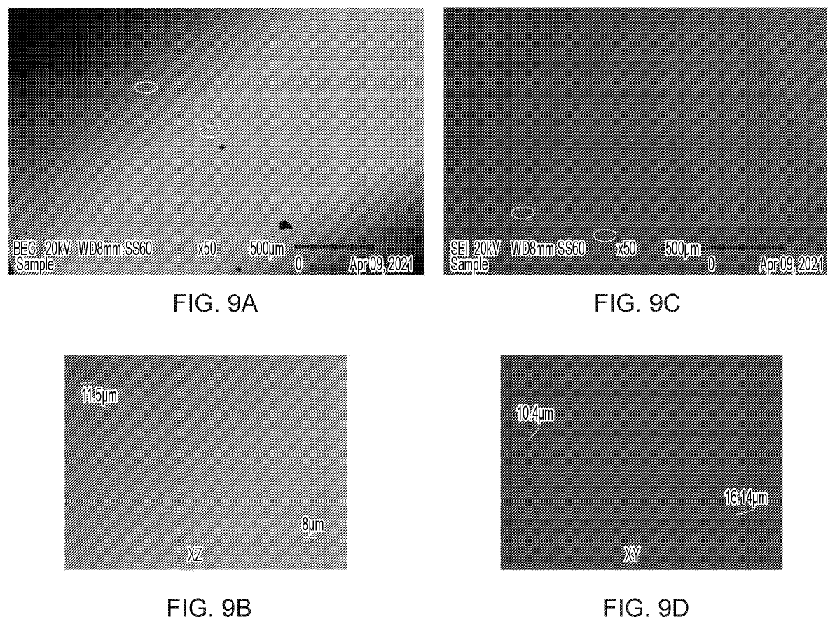

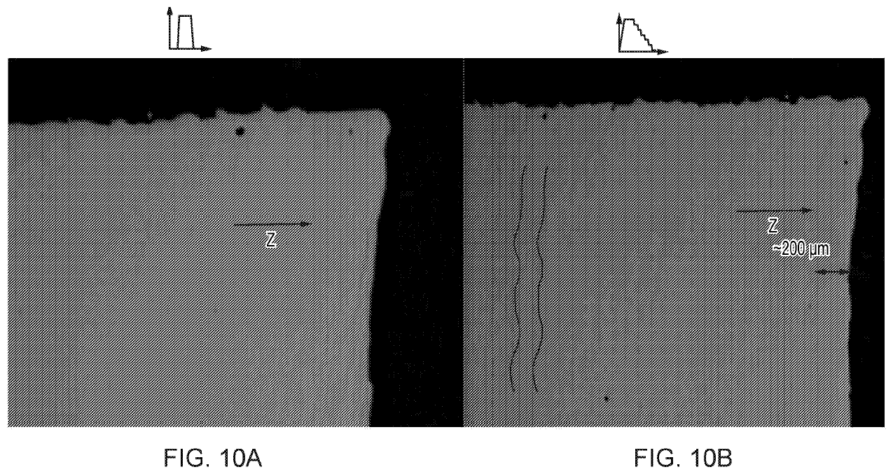

The presence of these smaller cracks with smooth surfaces is further supported by the SEM images of the cubes formed using gradual cooling pulses shown in FIGS. 9a to 9d. Very few cracks were observed, and the majority of the cracks were sub 20 μm.

### Example 2

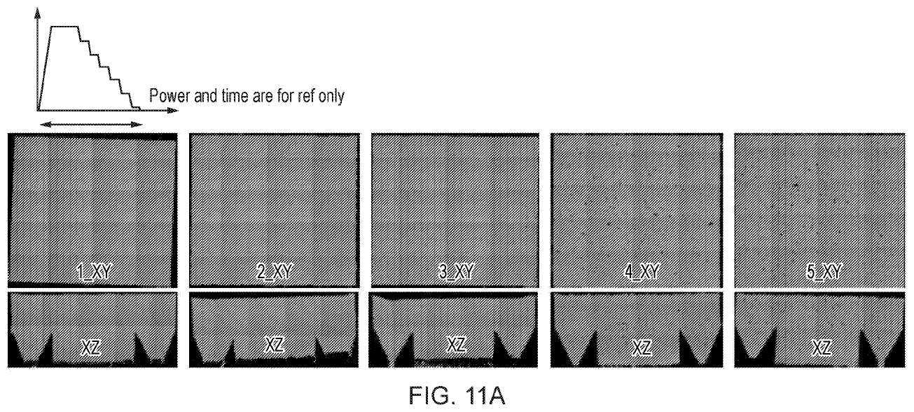

FIG. 10a is an image of a surface of a cube built using the rectangular pulses and FIG. 10b a corresponding image of a cube built using gradual cooling pulses. The highest z-plane is located at the right of the image (top of the page). As can be seen from the images, the melt pool depth is clearly visible for the gradual cooling pulses, whereas there is no clear corresponding feature visible for the cube built using rectangular pulses.

### Example 3

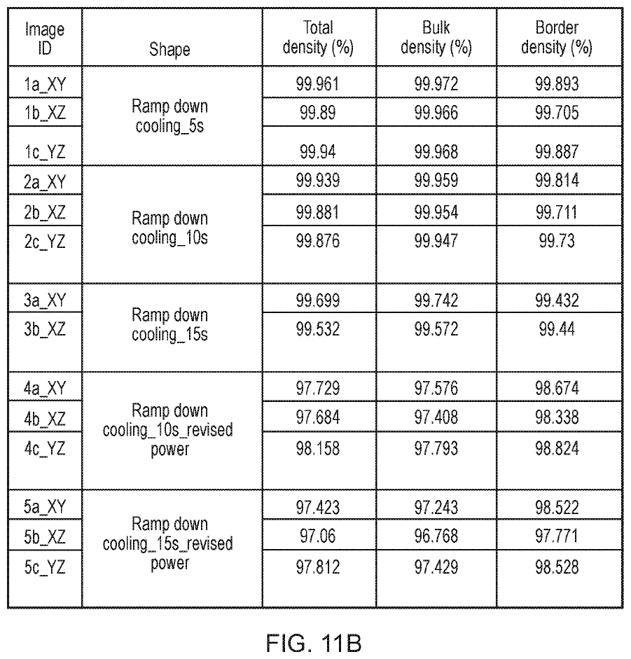

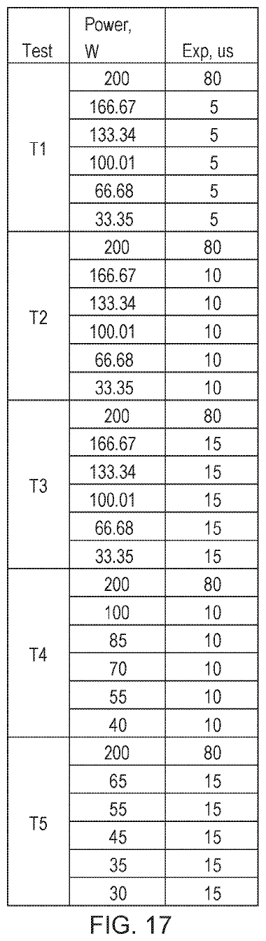

FIG. 11a shows cross-sectional images of 10 mm×10 mm×11.75 mm cubes T1 to T4 built in H13 tool steel with the modified RenAM 500E powder bed fusion machine using different gradual cooling pulses with (1) 5 μs steps, (2) 10 μs steps, (3) 15 μs steps, (4) 10 μs steps with revised power, and (5) 15 μs steps with revised power as shown in FIG. 17. A point distance of 65 μm, hatch distance of 80 μm and layer thickness of 40 μm was used. The same number of steps were used for each pulse. The revised power reduced the power of the steps to counter the increased power density supplied to the powder as the step duration is lengthened. The build parameters were: laser spot size was 80 μm, point distance 65 μm, hatch distance 80 μm, and a layer thickness of 40 μm.

As can be seen from FIG. 11b, the gradual cooling pulses with 5 μs steps achieved the highest density, although the density achieved by 10 μs steps was also acceptable. 15 μs steps did not result in good density for the cubes and neither did the pulses with the revised power. This suggests steps of less than 15 μs (or a continuous (no stepped) decrease in power) are preferable, with steps of 10 μs and 5 μs providing improved results. There does not appear to be an obvious correlation between step duration and power as revision of the power in line with a target energy density does not produce good density parts for 15 μs steps.

### Example 4

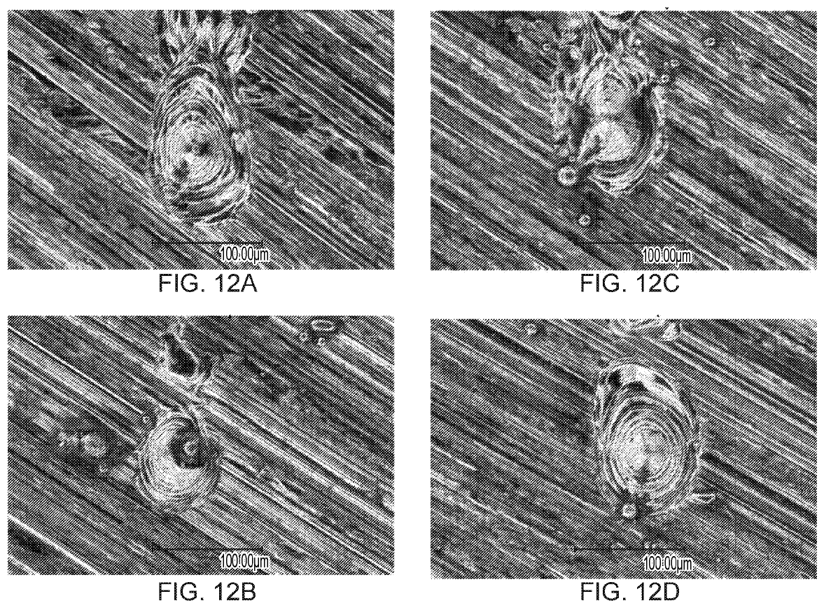

To explore the melt pool shapes formed by the different pulsed exposures, points on a bare metal substrate were exposed to a different one of pulse shapes. FIG. 12a is an image of a melt pool signature formed by a rectangular pulse, FIG. 12b is an image of a melt pool signature formed by a triangular pulse, FIG. 12c is an image of a melt pool signature formed by an initial blast pulse, and FIG. 12d is an image of a melt pool signature formed by a gradual cooling pulse with 5 μs steps. As can be seen each pulse shape creates a unique melt pool signature and this is expected to have an impact on track shape and the creation of gas-borne condensate. The melt pools formed by the rectangular and initial blast pulses appear more chaotic with matter ejected from the location of the exposure, whereas the triangular pulse and gradual cooling pulse create a more uniform melt pool shape. The melt pool for the rectangular pulse is smaller than that for the gradual cooling pulse.

### Example 5

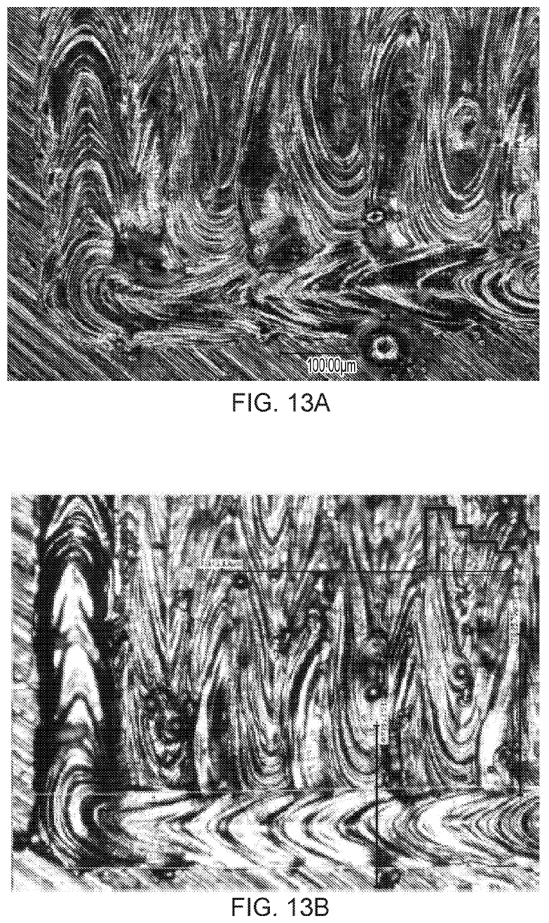

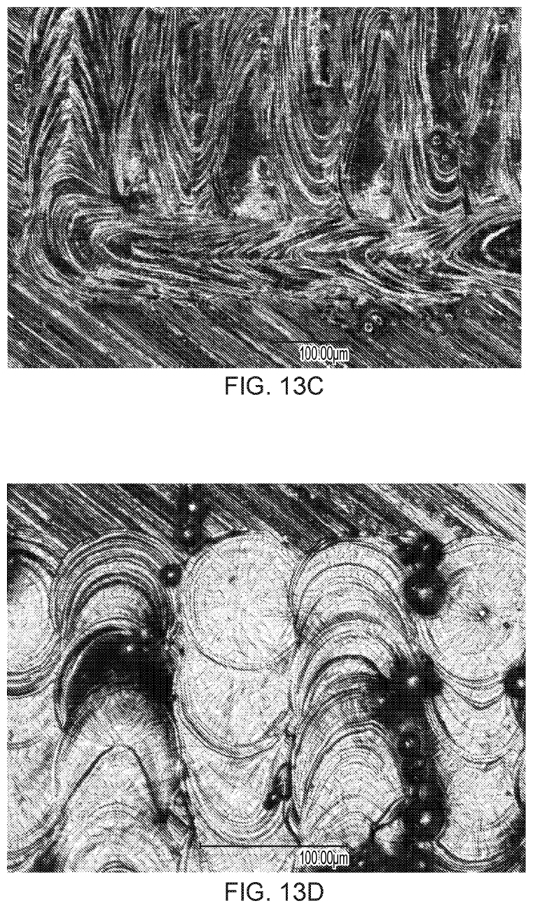

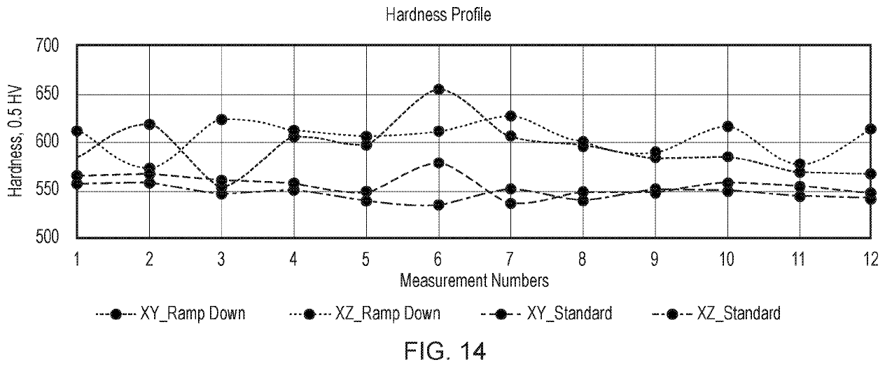

Metal tracks were formed on a bare metal substrate with the different pulsed exposures. The tracks comprised a plurality of hatch lines and a border scan. FIGS. 13a to 13d are images of these scans. FIG. 13a shows the end and start of hatch lines and a border scan for rectangular pulses, FIG. 13b shows the end and start of hatch lines and a border scan for gradual cooling pulses, FIG. 13c shows the end and start of hatch lines and a border scan for initial blast pulses and FIG. 13d shows the end and start of hatch lines and a border scan for triangular pulses. Melt track shape, size and noise level (balling) varies for the different shaped pulses (as would be expected from the melt pool signatures of Example 4). From the images, melting of the border track appears to be more consistent for the gradual cooling pulses compared to the rectangular pulses. No start and end hatch line defects were observed for the gradual cooling pulses and the rectangular pulses.

### Example 6

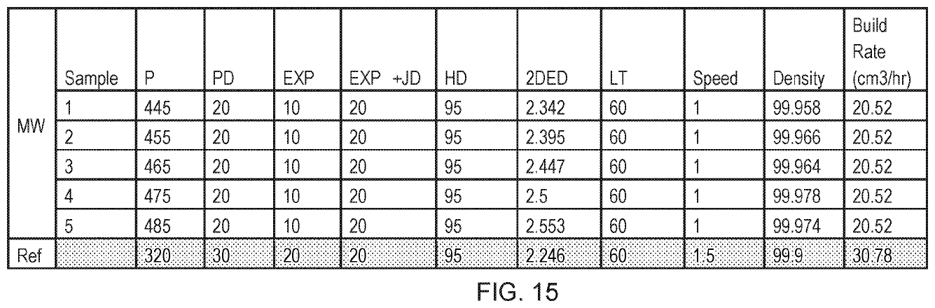

Samples were built in unsieved H13 tool steel in the modified RenAM 500E powder bed fusion machine using rectangular pulses and gradual cooling pulses. The hardness of the samples was measured. The samples built using the gradual cooling pulses had an average hardness 5% greater than that for the samples built using the rectangular pulses, as shown in FIG. 15.

### Example 7

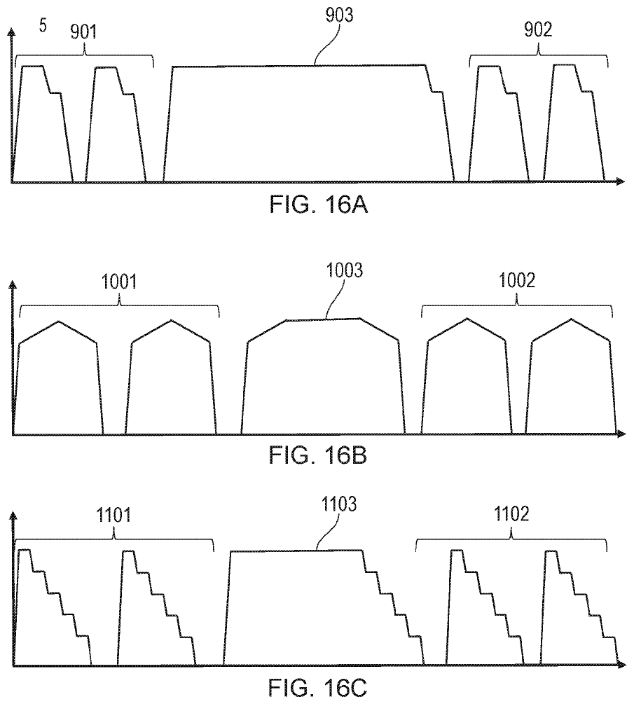

Five samples were built in titanium alloy Ti-6Al-4V with the modified RenAM 500E powder bed fusion machine using rectangular pulses with a total pulse duration of 10 μs. A 10 μs gap was provided between laser pulses. The parameters of the pulsed exposure used to build each sample are provided in the table of FIG. 16. The parameters are power (P) in Watts, point distance (PD) in μm, exposure time/pulse duration (EXP) in us and hatch distance (HD) in μm. The layer thickness (LT) was 60 μm. The delay between pulses is set by setting a variable called jump delay (JD) and the exposure time plus jump delay was set at 20 μs.

The 2D energy density (2DED), speed (PD/EXP+JD) and Build Rate have been determined from the other parameters. As can be seen from the table, density of greater than 99.9% of the theoretical density was achieved for the 10 μs pulsed exposures. Such shorter pulses may be useful for providing finer hatch lines. Furthermore, the shorter pulses may result in a higher cooling rate and accordingly, a different microstructure due to steeper thermal gradients generated across the melt pools compared to longer pulse durations. This finer microstructure may improve the properties of parts, in particular aluminium and aluminium alloys. Such short pulses may advantageously be used in distributed point scanning methods as described in WO2016/079496.

### Example 8

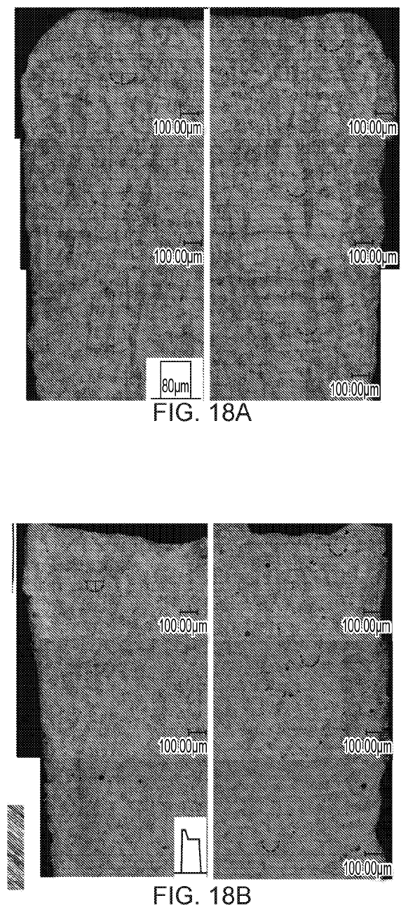

Samples were built in IN718 in the modified RenAM 500E powder bed fusion machine using rectangular pulses as shown in FIG. 7a and initial blast pulses as shown in FIG. 7b. As can be seen from FIGS. 18a and 18b, the rectangular pulses resulted in epitaxial grains whereas fewer epitaxial grains were observed in the material melted using initial blast pulses, e.g. the grains had a reduced length to width aspect ratio (grain homogeneity). This may be due to the more chaotic melt pool generated using the initial blast pulses (as shown in FIG. 12c).

In a further embodiment of the invention illustrated in FIGS. 16a to 16c, the pulsed exposure comprises a “blended pulsed exposure” wherein a scan path is irradiated using initial and/or end pulses 901, 1001, 1101; 902, 1002, 1102 of the pulsed exposure having a shorter pulse duration than a pulse duration of at least one mid-pulse 903, 1003, 1103 between the initial and end pulses. Typically, the start and/or end pulses 901, 1001, 1101; 902, 1002, 1102 have pulse duration of less than 200 μs, more typically less than 100 μs, and the mid-pulse 903, 1003, 1103 has a pulse duration of more than 200 μs (a continuous exposure) and will be dependent on the length of the scan path and the scan speed. The start and/or end pulses 901, 1001, 1101; 902, 1002, 1102 may be like the pulses described with reference to FIGS. 7a to 7h. In this embodiment, all of the start and/or end pulses 901, 1001, 1101; 902, 1002, 1102 have the same pulse duration. However, it will be understood that the pulse duration of the start and/or end pulses 901, 1001, 1101; 902, 1002, 1102 may vary.

FIG. 16a illustrates a blended pulsed exposure wherein the pulses have an initial blast pulse shape. FIG. 16b illustrates a blended pulsed exposure wherein the pulses have a triangular pulse shape. FIG. 16c illustrates a blended pulsed exposure wherein the pulses have a gradual cooling pulse shape. The lengths of the steps shown in FIG. 16c are schematic only and the first plateau may have a longer duration than the subsequent lower power steps.

It is believed use of such blended exposures may reduce defects observed at the start and end of hatch lines using conventional continuous mode scanning whilst benefiting from the faster processing achievable with scanning in continuous mode (as the laser is on for longer).

It will be understood that alterations and modifications may be made to the described embodiments without departing from the scope of the invention as defined herein. For example, other pulse shapes may be used. Furthermore, a build of a part may comprise using pulsed exposures to consolidate material for some areas and scanning in continuous mode to consolidate material for other areas.

1. A powder bed fusion additive manufacturing method comprising exposing layers of a powder bed to an energy beam to selectively melt areas of each layer, wherein at least a proportion of the areas are melted using a pulsed exposure, the method further comprising commanding an energy beam source to produce at least one pulse of the pulsed exposure having a pulse duration of less than 200 microseconds, the step of commanding comprising specifying a plurality of raised power levels above a base power level for the powder waveform of the at least one pulse.

2. A powder bed fusion additive manufacturing method according to claim 1, comprising commanding the energy beam source to produce each of a plurality of pulses having the power waveform and a pulse duration of less than 200 microseconds.

3. A powder bed fusion additive manufacturing method according to claim 1, wherein the step of commanding comprises specifying each of the plurality of raised power levels in a control signal sent to or that drives the energy beam source.

4. A powder bed fusion additive manufacturing method according to claim 1, wherein the step of commanding comprises specifying a pulse shape for the power waveform.

5. A powder bed fusion additive manufacturing method according to claim 4, wherein the power waveform is a non-rectangular pulse shape.

6. A powder bed fusion additive manufacturing method according to claim 4, wherein the pulse shape comprises a plurality of power plateaus at the raised power levels.

7. A powder bed fusion additive manufacturing method according to claim 1, wherein the pulse duration is greater than 1 microsecond.

8. A powder bed fusion additive manufacturing method according to claim 1, wherein the energy beam source has a response time of 10 microseconds or less.

9. A powder bed fusion additive manufacturing method according to claim 1, wherein the step of commanding comprises specifying one or more raised power levels between 10% and 90% of a maximum raised power level.

10. A powder bed fusion additive manufacturing method according to claim 1 comprising specifying one or more raised power levels as having a duration of less than 15 microseconds, optionally less than 10 microseconds, and further optionally, less than 5 microseconds.

11. A powder bed fusion additive manufacturing method according to claim 1, wherein the step of commanding comprises specifying a shape of the power waveform that decreases in a plurality of steps.

12. A powder bed fusion additive manufacturing method according to claim 11, wherein at least one step of the plurality of steps has a duration of less than 15 microseconds, optionally less than 10 microseconds, and further optionally less than 5 microseconds.

13. A powder bed fusion additive manufacturing method according to claim 11, wherein at least one step of the plurality of steps has a duration of greater than 1 microsecond, and further optionally greater than 2 microseconds.

14. A powder bed fusion additive manufacturing method according to claim 1, wherein the step of commanding comprises specifying a pulse shape to control a cooling rate of melt and/or resolidified material.

15. A powder bed fusion additive manufacturing method according to claim 1 wherein the step of commanding comprises specifying the power waveform such that the fall time is longer than the rise time.

16. A powder bed fusion additive manufacturing method according to claim 15 wherein the fall time of the at least one pulse is greater than 10 microseconds.

17. A powder bed fusion additive manufacturing method according to claim 15 wherein the fall time of the at least one pulse is less than 100 microseconds.

18. A powder bed fusion additive manufacturing method according to claim 1, wherein the step of commanding comprises specifying the power waveform such that the at least one pulse comprises a plurality of maxima.

19. A powder bed fusion additive manufacturing method comprising exposing layers of a powder bed to an energy beam to selectively melt areas of each layer, wherein at least a proportion of the areas are melted using a pulsed exposure, at least one pulse of the pulsed exposure having a pulse duration of less than 20 microseconds.
